(19) United States
(12) Patent Application Publication
(10) Pub. No.: US 2005/0200454 A1
(43) Pub. Date: Sep. 15, 2005

(54) Electronic lock and key assembly and operating method thereof

(76) Inventors: J. Carlos Martinez, Vitoria (ES); Santiago Azurmendi, Markina-Etxebarria (ES)

Correspondence Address: BIRCH STEWART KOLASCH & BIRCH, PO BOX 747, FALLS CHURCH, VA, 22040-0747, US

(21) Appl. No.: 10/511,305

(22) PCT Filed: Oct. 6, 2003
(86) PCT No.: PCT/ES03/00502

§ 371 Date: Oct. 15, 2004

(30) Foreign Application Priority Data
Oct. 8, 2002 (ES) P 200202289

(51) Int. Cl. E05B 49/00

(52) U.S. Cl. 340/5.65; 340/5.22; 340/5.6

(57) ABSTRACT

Electronic key and lock, which has the characteristic of having a series of electronic elements arranged within a capsule, the key having some means of storage of the opening code, as well as a LED diode for emitting the code, which is received by another receptor diode positioned on the lock, being stored and compared when received with the code recorded on the lock, acting on the electromechanical opening device. Both the key and the lock have a number of contacts for external connection by means of which the opening codes are recorded.

### PURPOSE OF THE INVENTION

The purpose of the present invention is a key and electronic lock and operating procedure of the assembly; namely, it refers to a system for opening of doors or similar based on a lock and key, where both elements are controlled electronically, having mechanical devices which are controlled by the electronics of the lock and of the key.

The present invention is characterized by its special configuration and design achieving a system of locking where the codes of the locking assemblies can be easily changed, the assembly has a greater useful life, the codes are undecipherable and the number of usable codes is unlimited.

The procedure by means of which the activation of the elements that comprise the locking system, and that allow the activation of the mechanical devices, is also object of the invention.

Therefore the present invention is encompassed within the ambit of locking systems based on lock and key where both elements are electronically activated.

### BACKGROUND TO THE INVENTION

Up until the present, opening systems differing from purely mechanical ones have been based on cards with a magnetic band or on perforated cards. These systems present several disadvantages, such as for example the difficulty of changing the keys, since it is not immediate, reprogramming being necessary. On the other hand, magnetic band cards and perforated cards are subject to continuous deterioration, being easily breakable.

Also, another disadvantage that the above mentioned systems present, is that they possess codes which can be decipherable or copiable, as well as allowing only a limited number of codes.

Therefore the present invention tries to overcome the previous disadvantages, developing a system of opening and closing that, based on the use of a key and lock that acts on some mechanical devices, may be activated by electronic means, both the key and the lock being encapsulated in plastic, that protects them against future deterioration. In addition, due to the fact that they are controlled and actuated by electronic means, it is possible to easily effect a change of codes, likewise it offers the possibility of having an unlimited number of codes.

### DESCRIPTION OF THE INVENTION

The present invention of electronic key and lock and its operating procedure consists basically of a key and a lock, where both elements are electronically controlled. In addition it has a number of mechanical devices in charge of the physical closing, that are controlled by the electronics of the key and the lock.

The key consists of an encapsulated plastic assembly that has an emitting diode of a determined 0 and 1 sequence at a determined frequency, within it; it also has a chip or means for storing the opening code, these means being reprogramable, for this purpose having means of connection with the exterior that allow the reprogramming of the codes. Finally, the key also has a number of metallic contacts, which when entering in contact with the contacts placed on the lock, trigger the emitting, reception and comparison of the opening code.

Said metallic contacts also serve as a means for supplying the key circuits. In order to avoid possible copying of the key code, when the appropriate voltage is applied to said contacts, the key can be fitted with other contacts, increasing the difficulty of provoking the emission of the code of the key.

In addition, the lock consists of two parts, a purely mechanical part entrusted with the physical opening and closing of the assembly to be opened or closed, and another electronic part, entrusted with the reception of the code emitted by the key and of the comparison.

The electronic part has a receiving diode of characteristics analogous to those of the emitting diode, this diode receives the opening code when the lock and key contacts make contact. As soon as the code is received it is stored, in the means provided for such purpose in the lock, later the comparison with the code recorded on the lock is made, acting on the opening control circuit that activates the mechanical devices.

In order to be able reprogram the codes stored in the lock it has an exterior connections bus, allowing the lock to be reprogrammed, whether remotely or placing it on reprogramming equipment connected to a computer.

Both the key and the lock must have supply, which is provided, either from the outside through a supply bus, or from the actual inside of the lock, and the necessary power is transmitted to the key through the lock and key contacts.

With purpose that the code issued by the key is readable by the lock, both parts must stay synchronized so that by means of an oscillator they have the same working frequency; thus when the key enters in the lock and triggers the emission of the code by means of an emitting diode, the lock is ready for the reception of this code.

Nevertheless, although this system is planned as means of access based on the use of an electronic lock and key, its ambit of application is not limited only to this field, being usable for means of access to enclosed areas when using a card, as well as also as means of control of credit cards, making the credit card act as an electronic key and the cash machine act as an electronic lock, logically with the due operational adjustments but always based on the same operating principle, already set-out.

In addition, to indicate that in any of the 25 aforementioned practical embodiments, the positioning of the LED emitter and receiver diode is indifferent, regarding where they are placed, whether in the electronic key or in the lock.

### DESCRIPTION OF THE DRAWINGS

To supplement this description and with the aim of leading to a better understanding of its characteristics, this report is accompanied by a set of drawings in whose figures, in an illustrative and non-limiting way, the most significant details of the invention have been represented.

FIG. 1. Shows the layout of the elements that comprise the key and electronic lock, object of the invention.

### PREFERRED EMBODIMENT OF THE INVENTION

In view of the figures mentioned a method of preferable embodiment of the invention is described below, as well as an explanation of the drawings.

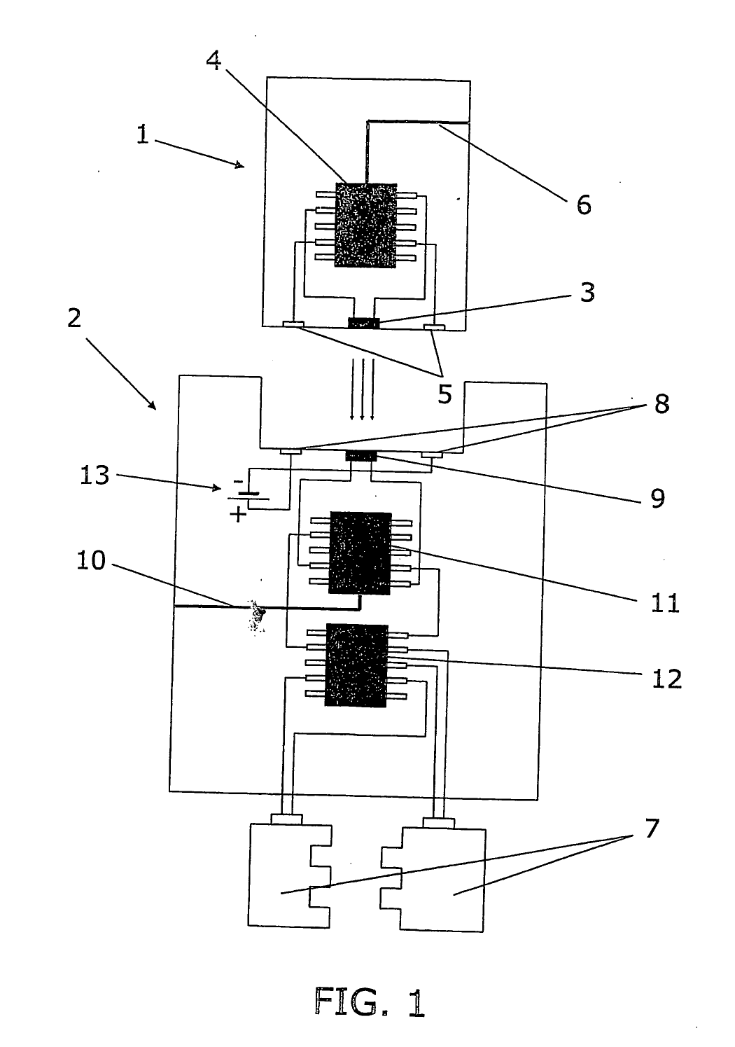

In FIG. 1, we observe that the object of the invention is formed by a key (1) and a lock (2), both electronically controlled, where the key (1), has a LED diode (2) within it, emitter of the opening code, this code being recorded in a storage device (4), also having a series of electrical contacts (5), that serve to receive the supply for the lock (2), as well as for receiving the signal by means of which the emission of the code is triggered.

Said code consists of a binary sequence, which is emitted at a certain frequency, which must coincide with the operating frequency of the lock (2).

With the purpose of being able to carry out the reprogramming of the key, this has an external access connector (6) from which the code that it is required to record in the key is provided.

We observe that the lock consists of an electronic part or assembly and of an assembly or means (7) of opening and closing. On the other hand, in the encapsulated interior of the lock (2), we find a receiving diode (9), of characteristics similar to those of the LED emitting diode (3), likewise a number of electrical contacts (8) arranged opposite the contacts (5) of the key (1).

Equally this lock (2) has a code storage device (11), as well as means of comparison of codes (12), where it is possible to record several opening codes, one for the assigned key, and another for the main key.

With the purpose of being able to undertake the recording of the codes onto the code comparing devices (12), the lock (2) has a connector for exterior connection (10). The recording of the codes can be carried out by means of a recording device connected to a personal computer, or remotely, using said connector (10) for connection.

It is not considered necessary to make more this description more extensive in order that any expert in the material may understand the scope of the invention and the advantages arising from it.

The materials, shape, size and layout of the parts will be liable to variation provided they don't alter essential nature of the invention.

The terms in which this report has been described must always be taken in a broad and non restrictive sense.

1. electronic key and lock among those used for the opening of systems of closing, characterized because both the key (1) and the lock (2) are electronically controlled, acting on electromechanical means of opening (7), both the key (1) and the lock (2) being encapsulated in plastic and the key having means of emitting and code storage, while the lock has some means for storing the code that is read and means for comparing the codes.

2. Electronic key and lock according to claim 1, characterized in that the key has a LED diode (3) emitter of the code recorded on some recording device (4), having a number of metallic contacts (5), through which it receives the power supply and the signal that triggers the emission of the code recorded in the recording device (5), in addition it has a connector (6) for external connection through which the recording of the codes is undertaken.

3. Electronic key and lock according to claim 1, characterized in that the lock (2) has a receiving diode (9), for the reception of the opening code, it also has some means for storing the code that is read (11) and means for comparing the codes (12) where the recorded codes are held and the comparison with the codes that have been read is undertaken. Furthermore it has an connector (10) for external connection, through which the recording of the lock codes is undertaken, it also has a number of contacts (8) arranged opposite the contacts (5) of the key (1), and through which the electric power from a battery (13) is supplied.

4. Electronic key and lock according to claim 1, characterized because the several codes can be recorded on the means of comparison (12) one corresponding with the actual opening code and another corresponding to the code of the master key.

5. Electronic key and lock according to claim 1, characterized in that the recording of the lock (2) codes can be carried out by means of a recording device connected to a personal computer, or remotely through the external external connection connector.

6. Electronic key and lock according to claim 1, characterized because the emitting (3) y receiving doides (8) can be laser diodes.

7. Electronic key and lock according to claim 1, characterized in that the lock has some means for storing the code that is read and means for comparing the codes, while the lock has some means for storing the code that is to be emitted, as well as means for emitting said codes.

8. Electronic key and lock according to claim 1, characterized in that the operational principle in which they are based is applicable to the credit card operation, likewise to any opening system, or access based on cards, where the card functions as an electronic key and the cash dispenser or the door accessed, as an electronic lock.

9. Operating procedure for the key and lock previously described, characterized in that for the opening process, first the key (1) is introduced into the lock (2), the contacts (5) and (8) entering in contact, triggering the emission of the opening code recorded in the key, based on a binary sequence at a determined frequency coinciding with the frequency of the lock (2), afterwards the signal emitted by the LED diode (3) is captured by the receiving diode (9), stored in some means of storage (11) and compared in some means of comparison (12), in order to proceed to act on the electromechanical opening and closing devices.
